(19) United States
(12) Patent Application Publication
(10) Pub. No.: US 2003/0025711 A1
(43) Pub. Date: Feb. 6, 2003

(54) System and method for visually calibrating a display based on just-noticeable-difference of human perception response

(75) Inventors: Chia-Sheng Kuo, Taipei (TW); Kuo-Young Cheng, Taichung Hsien (TW); Hui-Jan Chien, Taipei (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: DynaLab Inc.

(21) Appl. No.: 09/876,209

(22) Filed: Jun. 6, 2001

(51) Int. Cl. G09G 5/02

(52) U.S. Cl. 345/600

(57) ABSTRACT

A method for allowing a layman user to visually calibrate a user display is provided. First, a standard display model is predefined with (i) a standard display colorimetric transformation matrix, (ii) a standard display luminance response function, and (iii) three standard display human perception response (HPR) curves in dim, average, and bright environments, respectively. Second, a user display model is created, also including (i) a user display colorimetric transformation matrix, which is not fully defined, (ii) a user display luminance response function, which is also not fully defined, and (iii) a user display human perception response (HPR) curve in dim, average, or bright surrounding environment, as specified by the user. Third, the user display luminance response function is estimated. Fourth, the user display colorimetric transformation matrix is estimated. Finally, based on the above estimation, a lookup-table (LUT) is created for converting standard display signals to user display signals.

### FIELD OF THE INVENTION

The present invention relates to calibrating a display, and more specifically, to a system and method of visually calibrating a display based on just-noticeable-difference of human perception response, which can be readily implemented by a layman.

### BACKGROUND OF THE INVENTION

With the recent emergence of electronic commerce on the Internet, the demand has been increased for consistent color image reproduction in the displays of personal computer systems. For example, the color of products advertised and sold on the Internet should appear the same as the original color on every customer's personal computer. However, the same primary colors RGB (red, green, blue) values displayed in two different monitors (displays) may well produce two quite different color appearances due to configurational differences among displays. Thus, in order for a personal computer system to be able to reproduce the same color image appearance as the one intended by an image's originator, the computer system preferably includes a calibration system for calibrating a display. Clearly, to be user friendly, the calibration system is based on human perception (visual) response as opposed to relying on measurements obtained from optical instruments. In other words, a preferred calibration system performs “visual characterization” of a display.

Several prior art techniques for visual characterization have been proposed. These methods, however, require that a user possess a certain professional knowledge of colorimetry. These methods also require that a user make many tedious measurements. For example, U.S. Pat. No. 5,298,993 describes visual characterization by matching a high-frequency binary pattern to a region of a solid gray level, which is a method that relies on the optics of the eye to average a high-frequency pattern. The matching method requires that the user make numerous measurements of the output of a display at different gray levels throughout the grayscale. This approach is cumbersome, slow, and leads to inaccuracies. U.S. Pat. No. 5,754,222 describes a method of creating a display model having multiple parameters and determining the values of the parameters based on human visual selection. This method is also cumbersome as it requires a user to perform multiple procedures for determining each of the multiple parameters. Furthermore, this method is not user friendly to a layman, as it requires that a certain procedure be performed in a completely darkened room, for example. Such requirement is not practical to a layman (a typical Internet user) and prevents wide application of the method.

A need exists for a system and method for visual characterization of a display, which do not involve cumbersome steps and can be readily implemented by a layman. A layman is assumed to possess no special instruments, facilities, or professional knowledge of colorimetry.

### SUMMARY OF THE INVENTION

The present invention offers a method, computer-readable medium, and system for allowing a layman user to visually calibrate a user display, using just-noticeable-difference of human perception response.

In one embodiment, the method includes generally five steps. First, a standard display model is created. A standard display is a fully calibrated display, i.e., a display that can produce color images in the same colors as intended by the image originator, without converting any color signals as received. In the present invention, a standard display model is predefined as a reference model to be used later in defining an uncalibrated user display model. Specifically, a standard display model includes three components: (i) a standard display colorimetric transformation matrix, (ii) a standard display luminance response function, and (iii) three standard display human perception response (HPR) curves in dim, average, and bright surrounding environments, respectively. Each HPR curve correlates a color signal value to human perception response in each of these environments. Second, a user display model is created, also including three components: (i) a user display colorimetric transformation matrix, which is not fully defined, (ii) a user display luminance response function, which is also not fully defined, and (iii) a user display human perception response (HPR) curve in dim, average, or bright surrounding environment, as specified by the user. In the user display model, the calorimetric transformation matrix and the luminance response function are not fully defined because defining these components would typically require spectroradiometric measurement and some professional knowledge of colorimetry, which a typical user does not have. Third, therefore, according to the present method, the user display luminance response function is estimated based on the predefined standard display luminance response function, the predefined standard display HPR curve associated with the surrounding environment as specified by the user, and the user display HPR curve. Fourth, the user display calorimetric transformation matrix is estimated. Finally, a lookup-table (LUT) is created for converting standard display signals to user display signals, based on the estimated user display luminance response function and the estimated user display colorimetric transformation matrix.

Once an LUT is thus created, it is used for converting any standard signals received in the user display into user display signals, which will produce color images on the user display in the same colors as intended by the image originator.

In accordance with one aspect of the present invention, the standard display HPR curve and the user display HPR curve may be obtained by displaying a predefined pattern of images on a screen and evaluating an observer's perception response to just-noticeable-differences in the pattern. Specifically, first, a pattern is displayed on a screen wherein a plurality of images coded with a plurality of color signal values, respectively, are displayed. Second, an observer is prompted to select two images that have a just-noticeable-difference therebetween. Third, two color signal values corresponding to the two images having a just-noticeable-difference therebetween are recorded. These three steps are repeated until just-noticeable-differences are defined for the entire range of color signal values.

In accordance with yet another aspect of the present invention, the user display calorimetric transformation matrix is estimated by determining neutral color signals for the user display. Specifically, first, a plurality of colorimetric transformation matrices are defined for a plurality of known display models, respectively. Second, neutral color signals that produce a neutral color on the user display as seen by the user are determined. Third, a difference distance between the user display and each of the plurality of display models is calculated, based on the neutral color signals of the user display. Finally, the calorimetric transformation matrix of a display model that has the minimum difference distance from the user display is selected as the user display colorimetric transformation matrix.

In accordance with a further aspect of the present invention, neutral color signals on the user display are determined by displaying a predefined pattern of images on a screen and prompting the user to select one image that appears most color neutral. Specifically, first, a pattern is shown on the user display wherein a plurality of images are coded with a plurality of color signal values, respectively. Second, the user is prompted to select one image that appears most color neutral. These two steps are repeated, with each time varying the plurality of color signal values for coding the plurality of images, respectively, until the user can no longer select one image as most color neutral.

In accordance with a still further aspect of the invention, standard signals received in the user display are converted to user display signals, using a lookup-table (LUT), in generally four steps. First, a standard display signal is received in the user display. Second, a luminance response of the standard display signal is calculated using the predefined standard display luminance response function. Third, the luminance response of the standard display is transformed to a desired luminance response for the user display, using a suitable transformation matrix. Finally, the desired luminance response for the user display is plugged into an inverse of the user display luminance response function, to obtain a user display signal corresponding to the received standard display signal.

The present method may be applied in any monochromatic system or in any tristimulus system, such as an RGB tristimulus system. When used in a tristimulus system, the method is repeated three times for three tristimulus values (channels), respectively.

The invention further offers a system and computer-readable medium for generally executing a method of the present invention as described above.

Accordingly, the present invention provides a method, computer-readable medium, and system for calibrating a user display. Once calibrated, the user display can convert standard RGB signals to RᵤGᵤBᵤ signals so as to produce images on the user display in the same color appearance as the original images. The invention offers a simple and straightforward user interface to permit easy calibration of a user display. Therefore, each step of calibration can be performed without any knowledge of colorimetry, and thus can be readily performed by a layman, a typical Internet user. The computations involved in the calibration method are all autonomously performed by the system, and thus transparent to the user.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1A illustrates a computing environment, in which a system and method of the present invention may be implemented;

FIG. 1B is a system diagram illustrating several key components of the computer suitable for implementing a system and method of the present invention;

FIG. 2 is a flow diagram illustrative of an embodiment of the method of visually calibrating a user display, according to the present invention;

FIG. 3 is an example of a luminance response function graph, correlating a signal value to luminance;

FIG. 4 illustrates human perception response (HPR) function curves, each correlating a signal value to human perception response;

FIG. 5 is a sample pattern to be shown on a display, which is used for creating HPR function curves;

FIG. 6 schematically illustrates the process of defining n number of just noticeable differences throughout the entire signal value ranging from 0 to M (maximum value);

FIG. 7 illustrates a normalized HPR function curve;

FIG. 8 illustrates the first order derivative of a not yet normalized HPR function curve, used for obtaining a normalized HPR function of FIG. 7;

FIGS. 9A and 9B are flowcharts illustrating steps for creating HPR function curves and obtaining normalized HPR functions based thereon;

FIG. 10 is a sample screen view, which prompts a user to select one of three surrounding environments: dim, average, or bright;

FIG. 11 is a flowchart illustrating steps for estimating the normalized luminance response function for the user display;

FIGS. 12A-12C are flowcharts illustrating steps for estimating the calorimetric transformation matrix for the user display;

FIG. 13 lists white points of some common display models;

FIG. 14 lists phosphor types of some common display models;

FIG. 15 is a table showing a reference neutral value index for each display model characterized by particular phosphor type Pᵢ and white point class Iⱼ;

FIG. 16 is a sample pattern to be shown on a display, which is used for finding neutral color signals for the user display; and

FIG. 17 is a flowchart illustrating steps for creating a compensation model, or a look-up table (LUT), used for converting standard display signals RGB to the user display signals RᵤGᵤBᵤ.

### DETAILED DESCRIPTION OF THE PREFERRED EMBODIMENT

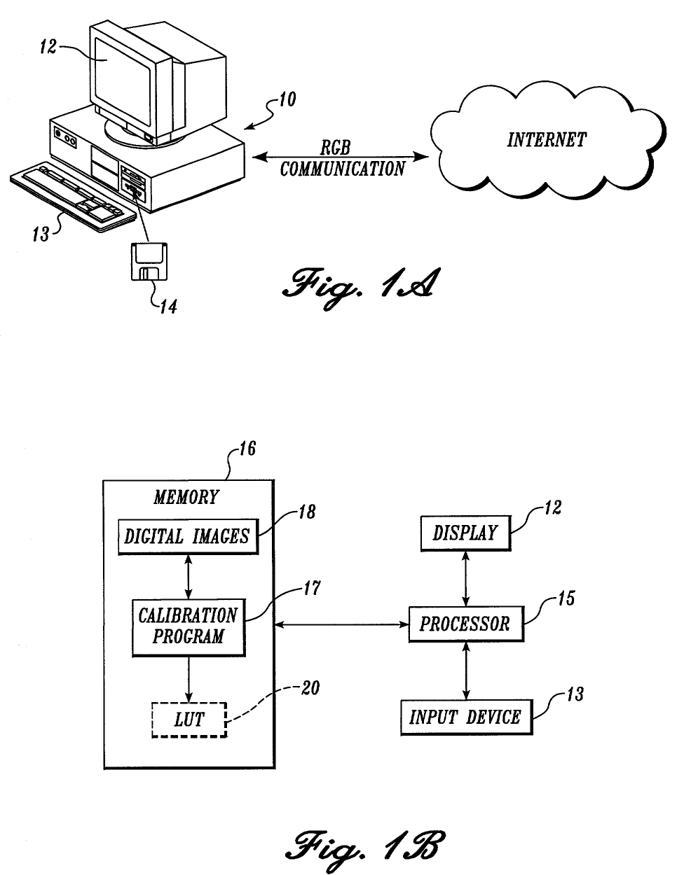

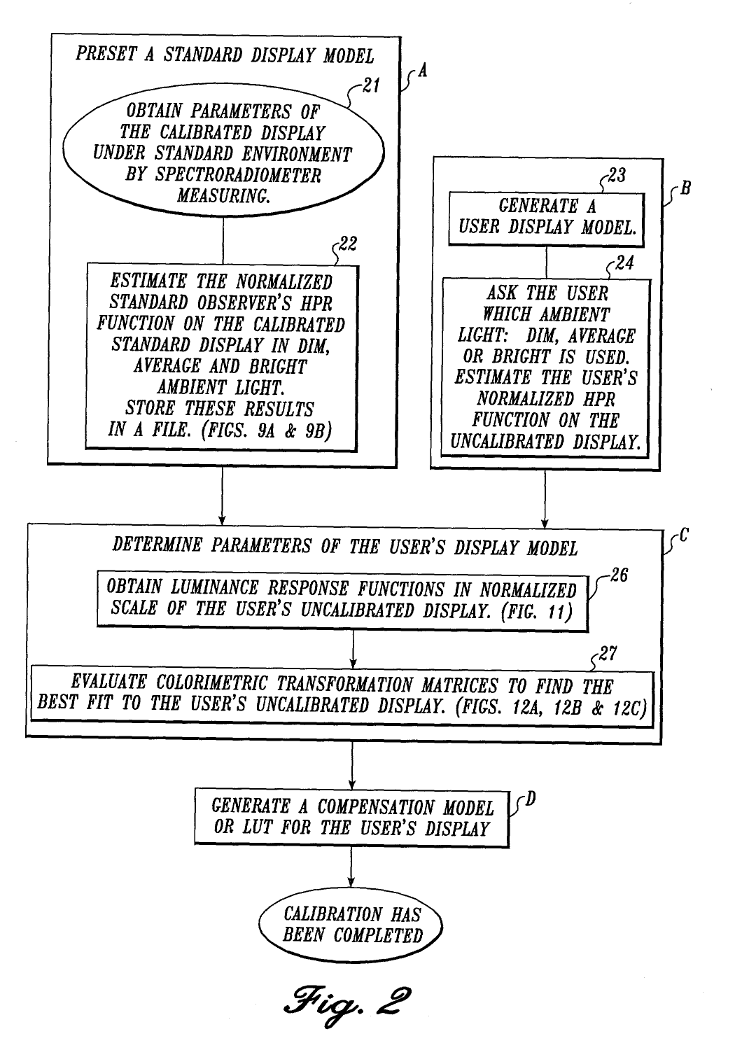

FIG. 1A illustrates a typical computing environment, in which a system and method of the present invention may be implemented. A general-purpose digital computer 10, including a display 12 and an input device 13, is fully capable of performing the method of the present invention. Other types of computing systems, such as networked or mainframe-based systems, may also be used to carry out a method of the present invention, as apparent to those skilled in the art. Typically, a method is embodied in a set of computer-executable instructions stored in a computer-readable medium 14 such as a disk, which is loaded onto the computer 10. The computer-executable instructions may also be created and stored in the computer 10 itself.

FIG. 1B depicts several key components of the computer 10, including a processor 15, and a memory 16 that is loaded with the computer-executable instructions for performing a method of the present invention. The memory 16 includes a calibration program 17 and a set of exemplary digital images 18. The calibration program 17, by displaying the digital images 18 to a user and measuring the user's response thereto, creates a look-up table (LUT) 20 that can be used to convert standard RGB signals to RᵤGᵤBᵤ signals calibrated for the user's display. Referring additionally to FIG. 1A, in operation, when RGB signals are received, via the Internet for example, the LUT 20 is used to convert the RGB values to RᵤGᵤBᵤ values. RᵤGᵤBᵤ values then reproduce color images on the user display 12 in the same color appearance as the original images coded with RGB values. According to the present invention, a user can thus visually calibrate the display 12 by merely entering the user's human perception response to what is shown on the display 12 via the input device 13. The calibration method is simple and straightforward, without requiring any instruments or any knowledge in colorimetry.

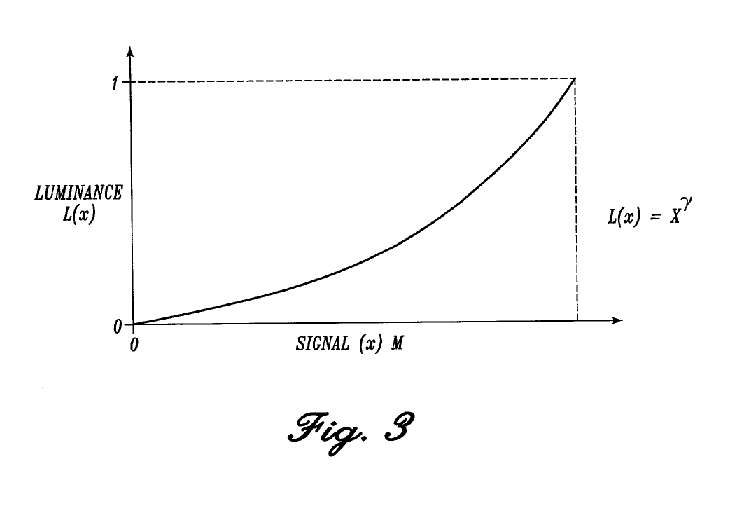

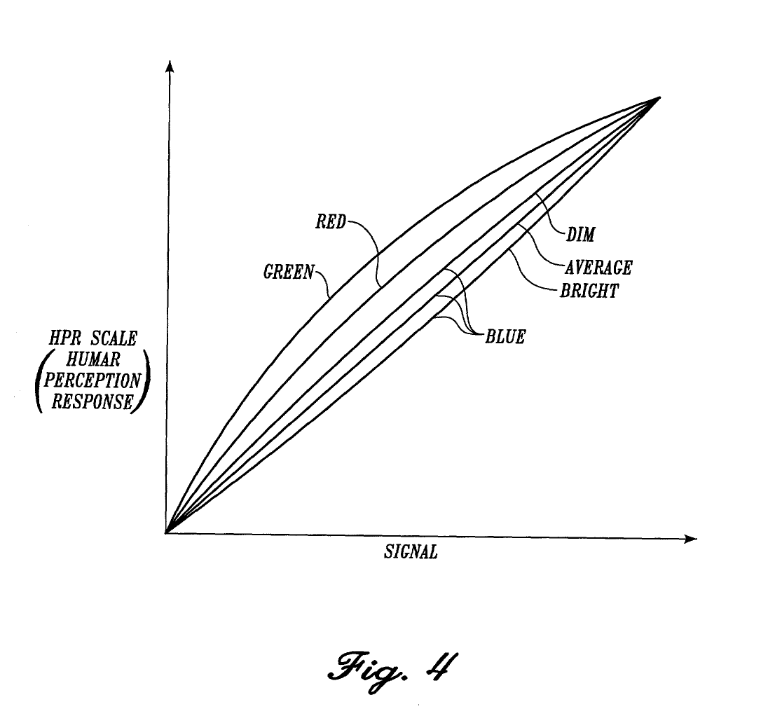

Referring to FIG. 2, a method of visually calibrating a user's display according to the present invention includes generally four steps A, B, C, and D. These four steps will be described in detail in Sections A-D below, respectively.

### A. Defining a Standard Display Model

In step A of FIG. 2, a standard display is modeled as a set of matrix and functions. The term “standard display” is used to indicate a display, which is adapted to display any color image in exactly the same appearance as the original image. In other words, the standard display is fully calibrated to display color images that are coded and transmitted over the Internet. The defined model of the standard display is stored in a file and will be used later as a basis for calibrating an uncalibrated display.

Step A includes two substeps 21 and 22. In substep 21, the standard display is modeled as a set of matrix and functions. The model is then defined using spectroradiometric measuring. Since this step involves spectroradiometric measuring, it is perhaps performed by the manufacturer of the computer-readable medium containing instructions for performing a method of the present invention, and not by an end user. The model definition is performed under standard (average) environment. In the present description, an average environment is defined as having just enough brightness to allow a user to clearly perceive text, for example newspaper text, though the brightness is not sufficient to allow the user to continue reading newspaper comfortably for any prolonged period of time. Under the average environment, first, a standard display is modeled by a calorimetric transformation matrix Mₛ, which is obtained according to the following procedure:

$$T = [ \begin{matrix}{x}_{r} & {x}_{g} & {x}_{b} \\ {y}_{r} & {y}_{g} & {y}_{b} \\ 1 - {x}_{r} - {y}_{r} & 1 - {x}_{g} - {y}_{g} & 1 - {x}_{b} - {y}_{b}\end{matrix} ] \qquad ( 1 )$$

where (xᵣ, yᵣ), (x_{g}, y_{g}), and (x_{b}, y_{b}) are phosphor coordinates under CIE 1931 XYZ system for the red, green, and blue channels, respectively,

$$[ \begin{matrix}α \\ β \\ γ\end{matrix} ] = {T}^{- 1} * [ \begin{matrix}{x}_{wp} / {y}_{wp} \\ 1 \\ {z}_{wp} / {y}_{wp}\end{matrix} ] \qquad ( 2 )$$

where α, β, γ are relative coefficients to form white point, with respect to R, G, B channels, and (x_{wp}, y_{wp}) is a white point coordinate under CIE 1931 XYZ system (z_{wp}=1−x_{wp}−y_{wp}). Then, the colorimetric transformation matrix Mₛ of the standard display is:

$${M}_{s} = T * [ \begin{matrix}α & 0 & 0 \\ 0 & β & 0 \\ 0 & 0 & γ\end{matrix} ] \qquad ( 3 )$$

Next, the standard display is further modeled with three luminance response functions for three color channels, respectively, as follows:

Lᵣ^{s}(R) (4)

L_{g}^{s}(G) (5)

L_{b}^{s}(B) (6)

The luminance response function is a mapping function that relates signal values (R, G, B) ranging from 0 to M (maximum signal, e.g., 255 in the case of an 8-bit system) to a normalized luminance output as measured by a spectroradiometer, ranging from 0 to 1. Once the matrix (3) and the mapping functions (4), (5), and (6) are defined, they are stored in a file.

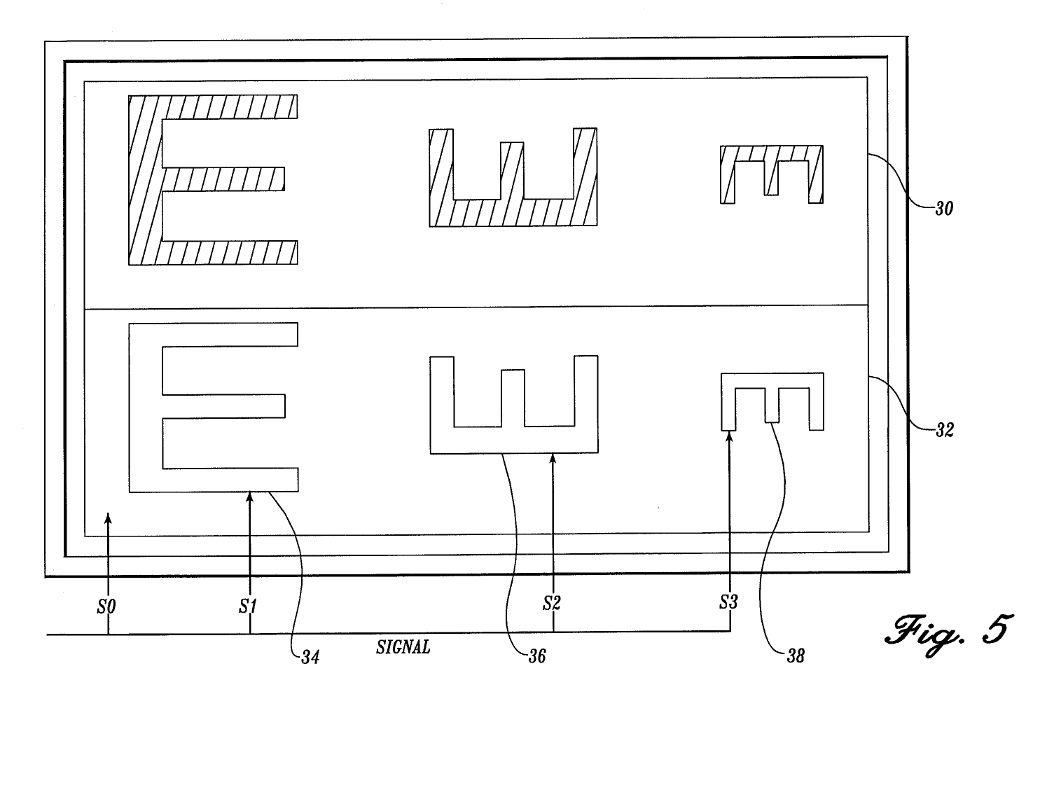

Next in substep 22, referring additionally to FIG. 4, for each of the color channels, three human perception response (HPR) characteristic curves are created on the standard display (i.e., the calibrated display), each associated with a dim, average, or bright surrounding environment, respectively. In the present description, the terms dim, average, and bright are defined as follows:

Dim environment does not have sufficient brightness to allow a user to clearly perceive text, for example newspaper text;

Average environment has just enough brightness to allow a user to clearly perceive text, for example newspaper text, though the brightness is not sufficient to allow the user to continue reading newspaper comfortably for any prolonged period of time; and

Bright environment has at least sufficient brightness to allow a user to clearly perceive text, for example newspaper text, comfortably for a prolonged period of time, including such environment which may be too bright for the user to read text easily.

Thus, nine HPR characteristic curves are created in total. Though FIG. 4 shows only five such curves, wherein dim, average, and bright HPR characteristic curves are created for blue only, it should be understood that these three curves are created for red and green also. These curves are obtained by a tester operating under a dim, average, or bright surrounding environment. Thus, this step is also performed, perhaps, under the control of the manufacture of the computer-readable medium including instructions for performing a method of the present invention, and not by an end user. Then, based on the nine HPR characteristic curves thus created, nine normalized HPR functions are estimated, respectively, as will be more fully described below.

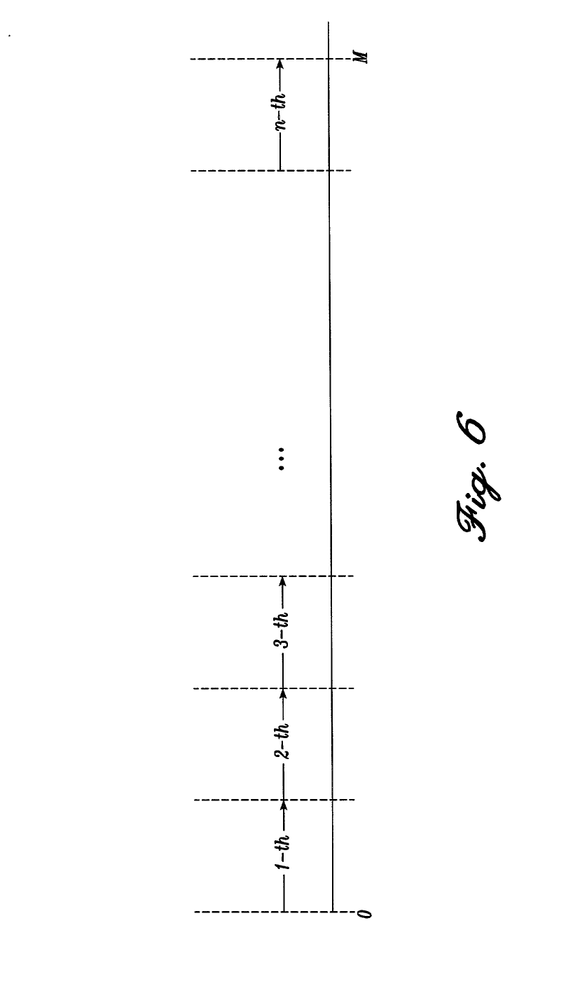

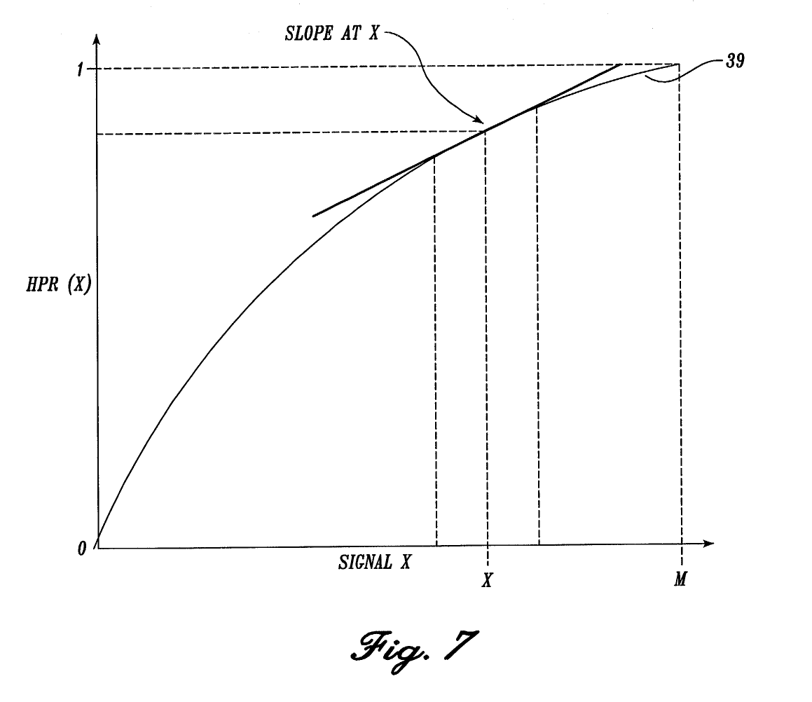

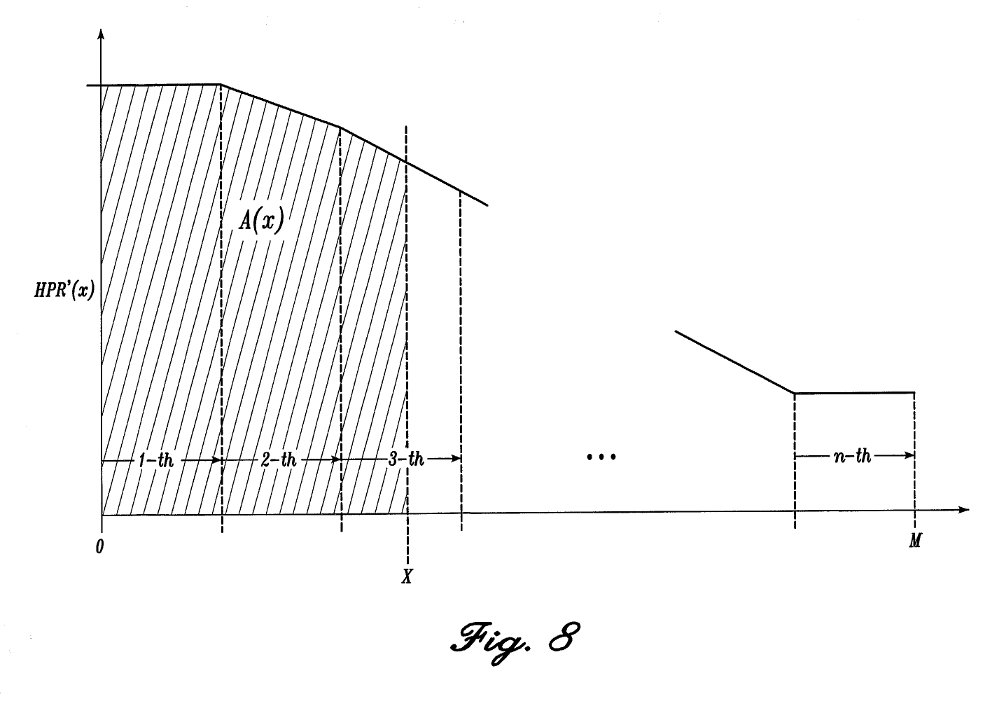

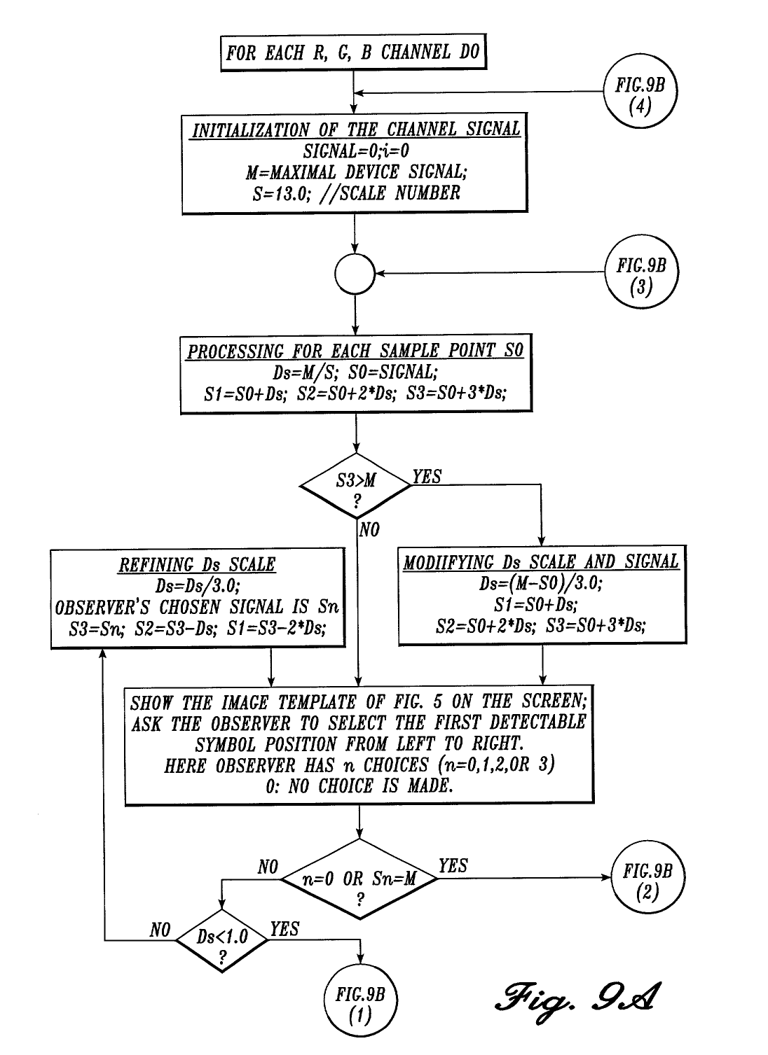

The detailed steps for obtaining nine HPR characteristic curves and estimating normalized HPR functions based on these curves are now described. First, a pattern such as FIG. 5 is shown on the display 12. FIG. 5 includes two rows. In the upper row 30, a randomly generated symbol (e.g., an eye examination symbol) is shown in three different sizes, the leftmost the largest and the rightmost the smallest. The symbols may appear rotated by different angles (0°, 90°, 180°, 270°, etc.), as illustrated. In the bottom row 32, the randomly generated symbols also appear in the identical pattern as in the upper row, except that signals (code values, ranging from 0 to 255 for an 8-bit system) filling in the symbols in the bottom row are varied.

Specifically, in the red channel, test signals are (Si, 0, 0); i=0, 1, 2, 3. In the bottom row of FIG. 5, the background signal S₀ is set to x while the largest symbol 34 (foreground) is filled with signal S₁=(x+Δx), the middle symbol 36 with signal S₂=(x+2Δx), and the smallest symbol 38 with signal S₃=(x+3Δx). Similarly, green and blue channel signals are (0, Si, 0) and (0, 0, Si), respectively.

A tester is then prompted to indicate whether he can see any of the symbols 34, 36, and 38 from left to right. For example, if the tester cannot see the largest symbol 34 but can see the middle symbol 36, it is determined that there is just noticeable difference between the background and the middle symbol 36, though there is no noticeable difference between the background and the largest symbol 34. The term “just noticeable difference” refers to the threshold of perceptibility, wherein a symbol can be just seen or distinguished from the background.

Continuing the same example, when the tester selects that the middle symbol 36 is just noticeable, then the pattern of FIG. 5 will change, this time setting the previous foreground signal of the middle symbol 36 (x+2Δx) that the tester has indicated to be just noticeable, as the new foreground signal S₃(38), and resetting the foreground signals of the symbols as 34 (S₃−2Δx) and 36 (S₃−Δx) accordingly. The tester is again prompted to indicate if he can distinguish any of the symbols from the new setting. Assuming that the signal code value (x) of a display channel ranges between 0 and M, referring to FIG. 6, the process is repeated n times (i.e., n number of just-noticeable-differences are found) to cover the entire code value range. Note that n may vary depending on individual observers; two different people may well yield two different n, one being able to discern color differences in smaller increments than the other. However, for the purpose of simplicity, n may be taken as a constant, for example 10, meaning that 10 different perceptable levels of red, green, or blue can be differentiated by an average observer. Then, each of the just noticeable differences may also be treated as a constant, 1/n, which is referred to as a just noticeable difference (JND) unit in the present description. The JND indicates a unit in human perception response (HPR) by which a just noticeable difference is discerned.

Plotting the observer's response to just noticeable differences under a dim, average, or bright surrounding environment will yield three HPR characteristic curves for each of three color channels, as shown in FIG. 4.

FIG. 7 illustrates a normalized HPR characteristic curve, wherein HPR(0)=0 and HPR(M)=1. As illustrated, estimation of a normalized HPR characteristic curve function is a process to determine a curve between (0, 0) and (M, 1) that best fits the observer's perception response. The estimation of a normalized HPR function is now described in detail. FIG. 8 illustrates HPR′(x) function, which is a slope function (first order derivative) of the original (not yet normalized) HPR(x). As illustrated, the HPR′(x) function is plotted by recording a slope at each of the n number of just noticeable differences perceived by the observer throughout the signal ranging between 0 and M.

Next, let A(x) denote the area function of x beneath the HPR′(x) in FIG. 8, and A be the total area, as follows:

$$\begin{matrix}A ( x ) = {\int }_{0}^{x} {HPR}^{′} ( x ) ⅆ x & ( 7 ) \\ A = {\int }_{0}^{M} {HPR}^{′} ( x ) ⅆ x & ( 8 )\end{matrix}$$

Then, a normalized HPR(x) for the standard display can be expressed as:

$${HPR}^{s} ( x ) = \frac{A ( x )}{A} \qquad ( 9 )$$

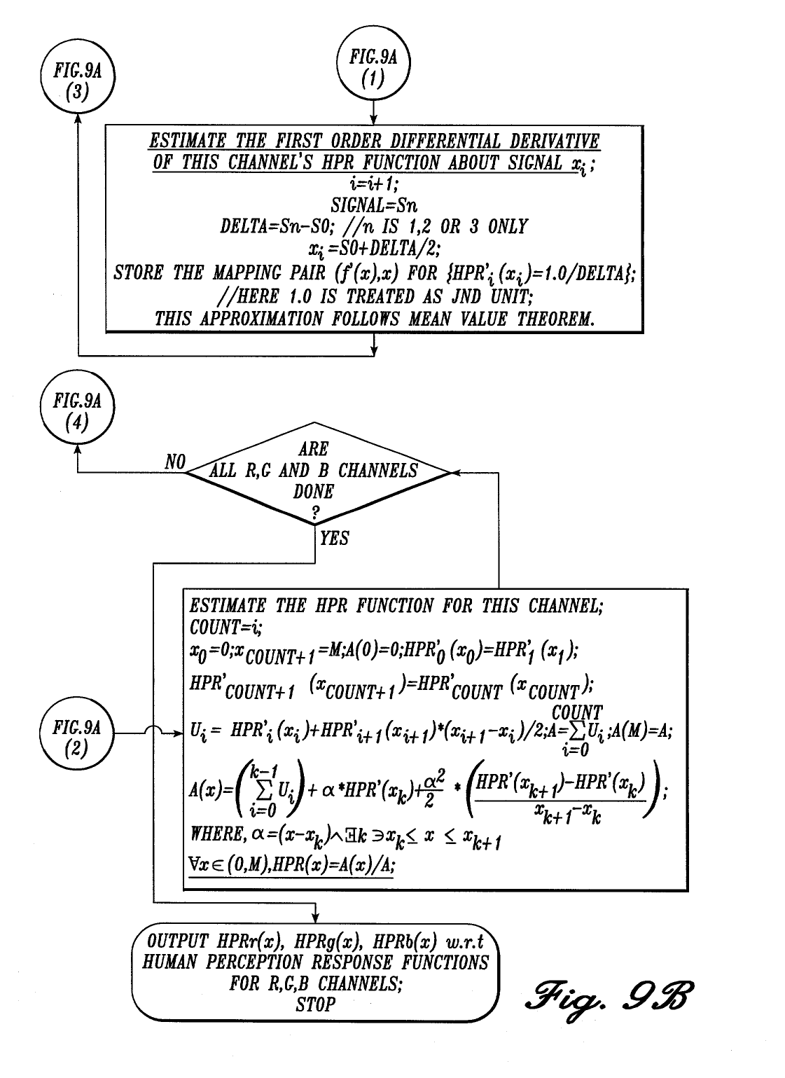

The above steps are performed for all three channels, in dim, average, and bright surrounding environments, until nine normalized HPR(x) functions are obtained. These functions are then stored in a file. One embodiment of steps for creating HPR characteristic curves and obtaining normalized HPR(x) functions based thereon is illustrated in a detailed flow diagram of FIGS. 9A and 9B. (In FIGS. 9A and 9B, Δx=Ds).

The standard display model is now complete. The standard display model consists of one matrix equation (3); three luminance response functions (4), (5), and (6); and nine normalized HPR(x) functions, as shown in equation (9), for each of the three color channels, HPRᵣ(R), HPR_{g}(G), and HPR_{b}(B), in each of three surrounding environments, dim, average, and bright.

As will be appreciated based on the following description, step A of defining a standard display model is typically performed under the control of the manufacturer of the computer-readable medium containing instructions for performing a method of the present invention, and not by an end user. In other words, a standard display model is defined and stored in a file, to be later used in steps B-D below, which are typically performed by an end user.

### B. Defining a User Display Model

Next, referring back to FIG. 2, in step B substep 23, a user display model is created. The user display model represents a particular user's display, which is not yet calibrated, i.e., which may display color images coded and transmitted over the Internet differently from how the original images appear. Similarly to the standard display model described above in reference to matrix equations (1), (2), and (3), the user display can be modeled as a 3×3 matrix:

$${M}_{u} = T * [ \begin{matrix}α & 0 & 0 \\ 0 & β & 0 \\ 0 & 0 & γ\end{matrix} ] \qquad ( 10 )$$

where matrix T and parameters α, β, and γ are unknown in this case.

Further as in the standard display, the user display can be additionally modeled with three luminance functions:

Lᵣ^{u}(R) (11)

L_{g}^{u}(G) (12)

L_{b}^{u}(B) (13)

As before, the user display luminance response function is a mapping function that relates signal values (R, G, B) ranging from 0 to M (maximum signal, e.g., 255 in the case of an 8-bit system) to a normalized luminance output as measured by a spectroradiometer, ranging from 0 to 1. As with the calorimetric transformation matrix of equation (10) above, the luminance response functions of the user display are not yet defined. The undefined matrix (10) and functions (11), (12), and (13) are stored in a file, to be later estimated in section C below.

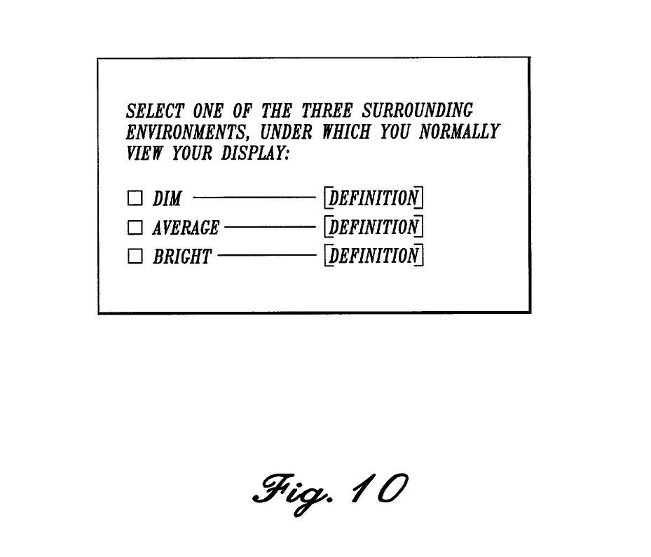

In substep 24, the user is asked under which ambient light he is using his uncalibrated display: dim, average, or bright. A sample user interface is shown in FIG. 10, illustrating a screen prompting the user to select one of three surrounding environments.

Thereafter, the user is prompted to create three HPR characteristic curves, each associated with one of three tristimulus channels, using patterns as shown in FIG. 5. From the three HPR curves thus created, three normalized HPR functions, as expressed in equation (9) above, are obtained for each of three channels:

$$\begin{matrix}{HPR}_{r}^{u} ( R ) = \frac{A ( R )}{A} & ( 14 ) \\ {HPR}_{g}^{u} ( G ) = \frac{A ( G )}{A} & ( 15 ) \\ {HPR}_{b}^{u} ( B ) = \frac{A ( B )}{A} & ( 16 )\end{matrix}$$

Note that these HPR functions expressed in equations (14), (15), and (16) are obtained under a specific surrounding condition (dim, average, or bright), as previously identified by the user. Thus, these HPR functions are stored in a file in association with the selected surrounding environment of the user display. For example, if the user has selected “average” environment, then the equations (14), (15), and (16) are stored in association with “average” condition.

### C. Determining Parameters of the User Display Model

Next, in step C, the colorimetric transformation matrix (10) and luminance response functions (11), (12), and (13) of the user display are estimated.

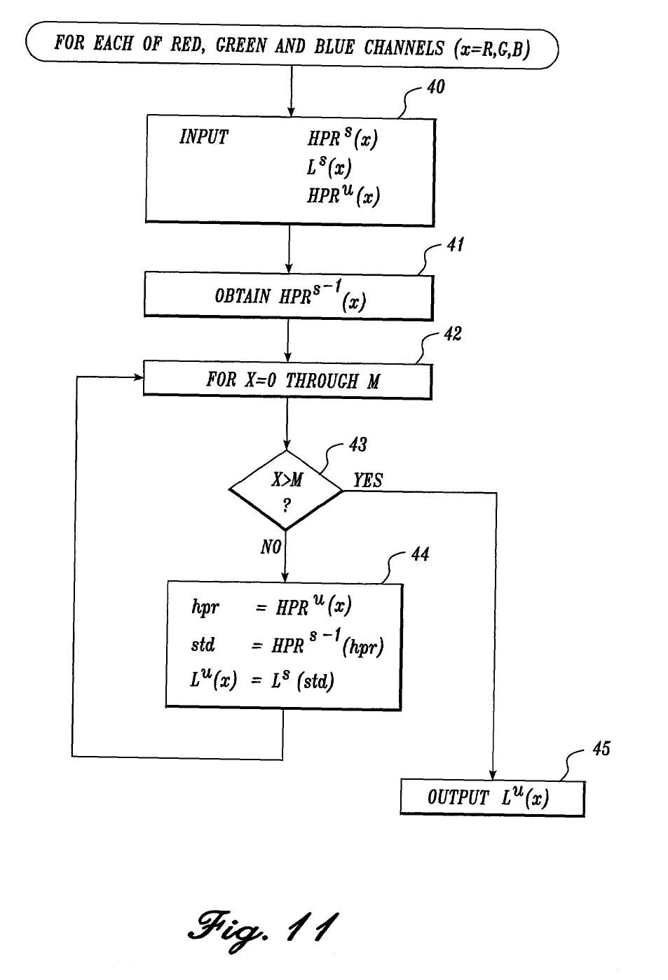

First, in substep 26, the luminance response functions (11), (12), and (13) of the user display are estimated. FIG. 11 illustrates detailed steps for estimating the normalized luminance response functions. For each of red, green, and blue channels (x=R, G, or B), in step 40, the predetermined functions for the standard display, HPR^{s}(x) (from equation (9) above) and L^{s}(x) (from equations (4) for red, (5) for green, or (6) for blue above) are retrieved as input. Further, the predefined function for the user display HPR^{u}(x) (from equations (14), (15), or (16)) is retrieved. Note that HPR^{s}(x) function for the standard display selected in step 40 is the one corresponding to the surrounding environment selected by the user. For example, if the user selected “dim” environment as his surrounding environment in substep 24 above, HPR^{s}(x) of the standard display for dim environment is used as an input.

Next, in step 41, an inverse function of HPR^{s}(x) for the standard display, HPR^{s-}^{¹}(x), is obtained. Next, for signal x ranging from 0 through M (steps 42 and 43), the following calculations are performed to estimate L^{u}(x) for the user display model (step 44):

hpr=HPR^{u}(x) (17)

std=HPR^{s-}^{¹}(hpr) (18)

L^{u}(x)=L^{s}(std) (19)

Essentially, equations (17) and (18) estimate, for each signal level x (R, G, or B) ranging between 0 and M producing a particular HPR level on the user display, what signal level “std” is required to produce the same HPR level on the standard display. Then, equation (19) equates the luminance of the standard display obtained with signal “std” with the luminance of the user display obtained with signal “x”. When the luminance response function for the user display is thus mapped for the entire signal range, i.e., x=0 through M (step 43), then in step 45, fully mapped luminance response function L^{u}(x) is output.

The above process is repeated for each of the three channels, so as to obtain Lᵣ^{u}(R), L_{b}^{u}(B), and L_{g}^{u}(G).

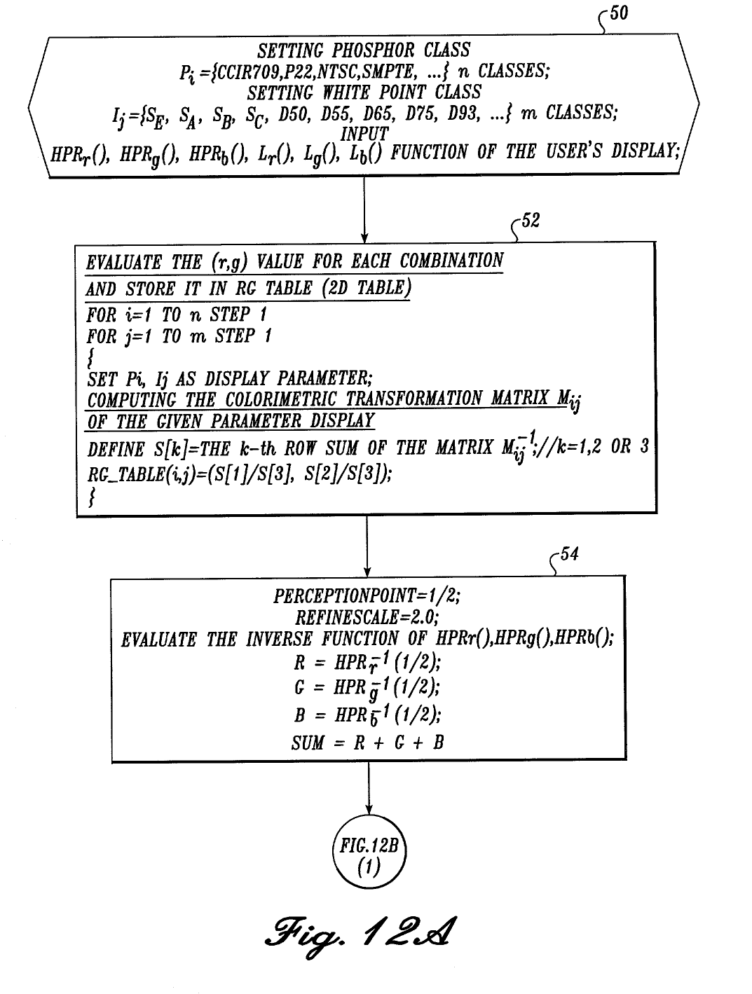

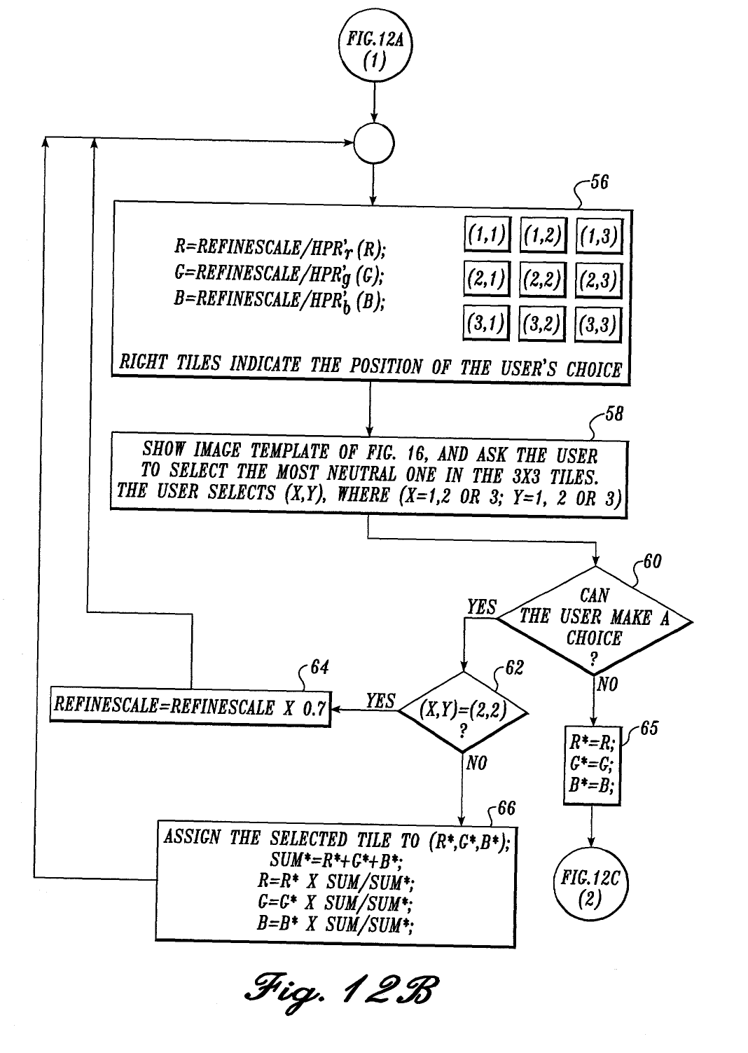

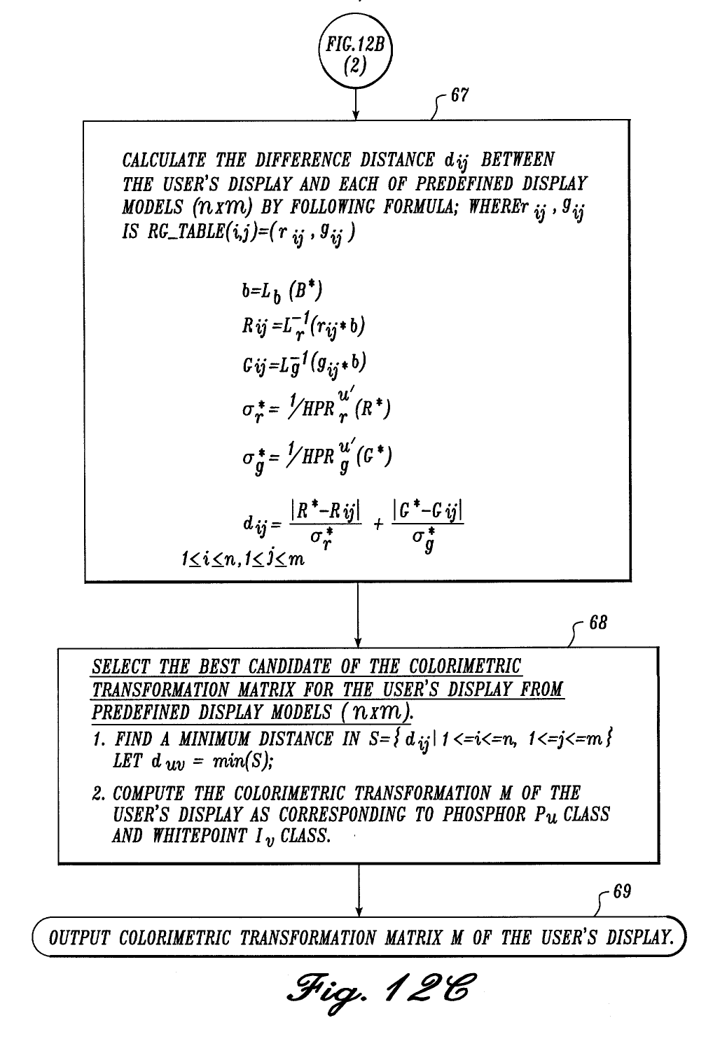

Next, referring back to FIG. 2, in substep 27, colorimetric transformation matrix Mᵤ of the user display (from equation (10) above) is estimated. Briefly, Mᵤ is estimated by evaluating a user's response to images created on the display to find neutral color signals that produce a neutral color on the user display, and selecting one of a plurality of predefined colorimetric transformation matrices that best models the user's response. FIGS. 12A-12C describe detailed steps for estimating the user display Mᵤ.

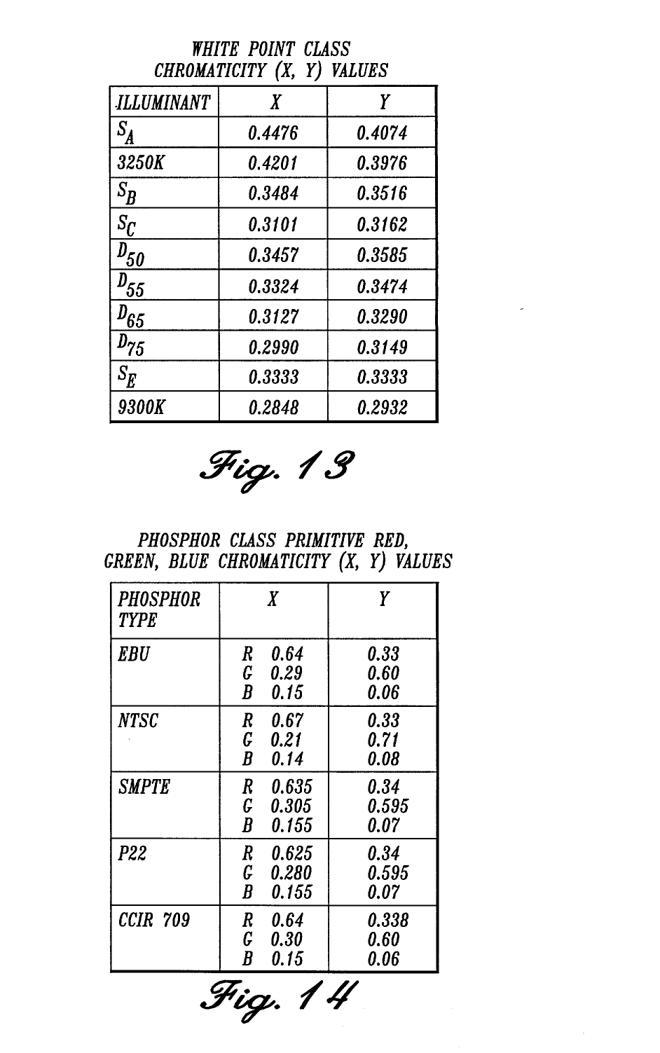

In step 50, a plurality of calorimetric transformation matrices for known display models are defined. As described in equations (1), (2), and (3) above, a calorimetric transformation matrix is defined by phosphor coordinates and a white point. Thus, letting P₁(i=1, . . . , n) denote iₜₕ phosphor type commonly used in a display model (e.g., CCIR709, P22, NTSC), and Iⱼ(j=1, . . . , m) denote a white point commonly seen in a display model (e.g., D₅₀, D₅₅, D₆₅), there are n×m number of matrices Mᵢⱼ to characterize all types of known display models. FIGS. 13 and 14 show white points and phosphor types, respectively, of some common display models.

Still referring to step 50, the normalized HPR functions for the user display HPR^{u}(x) for red, green, and blue channels are retrieved as input (from equations (14), (15), and (16)). Furthermore, the normalized luminance response functions L^{u}(x) for red, green, and blue channels for the user display, as determined in equation (19) above, are also retrieved as input.

Next, in step 52, n×m number of matrices Mᵢⱼ are computed as below:

For each of n×m number of display models:

$$\begin{matrix}{T}_{ij} = [ \begin{matrix}{x}_{r} & {x}_{g} & {x}_{b} \\ {y}_{r} & {y}_{g} & {y}_{b} \\ 1 - {x}_{r} - {y}_{r} & 1 - {x}_{g} - {y}_{g} & 1 - {x}_{b} - {y}_{b}\end{matrix} ] & ( 20 ) \\ [ \begin{matrix}α \\ β \\ γ\end{matrix} ] = {T}_{ij}^{- 1} * [ \begin{matrix}{x}_{wp} / {y}_{wp} \\ 1 \\ {z}_{wp} / {y}_{wp}\end{matrix} ] & ( 21 ) \\ {M}_{ij} = {T}_{ij} * [ \begin{matrix}α & 0 & 0 \\ 0 & β & 0 \\ 0 & 0 & γ\end{matrix} ] & ( 22 )\end{matrix}$$

Next, a reference neutral value index of each Mᵢⱼ is determined. The reference neutral value index is the normalized coordinate of neutral color signals. For example, if certain (Rⁿ, Gⁿ, Bⁿ) signals produce a color that appears neutral among red, blue, green, and yellow colors to an observer (grayish color), such signals are called neutral color signals. By setting Bⁿ=1, one can obtain normalized (r, g) signals, i.e., (r=Rⁿ/Bⁿ, g=Gⁿ/Bⁿ), for producing a neutral color. The normalized (r, g) signals thus obtained are collectively called the reference neutral value index. Specifically, let Sᵢⱼ^{<k>} denote sum of k^{th} row of Mᵢⱼ⁻¹. Then, a reference neutral value index (rᵢⱼ, gᵢⱼ) of a particular display model represented by matrix Mᵢⱼ can be obtained as follows:

$$\begin{matrix}{r}_{ij} = \frac{{S}_{ij}^{< 1 >}}{{S}_{ij}^{< 3 >}} & ( 23 ) \\ {g}_{ij} = \frac{{S}_{ij}^{< 2 >}}{{S}_{ij}^{< 3 >}} & ( 24 )\end{matrix}$$

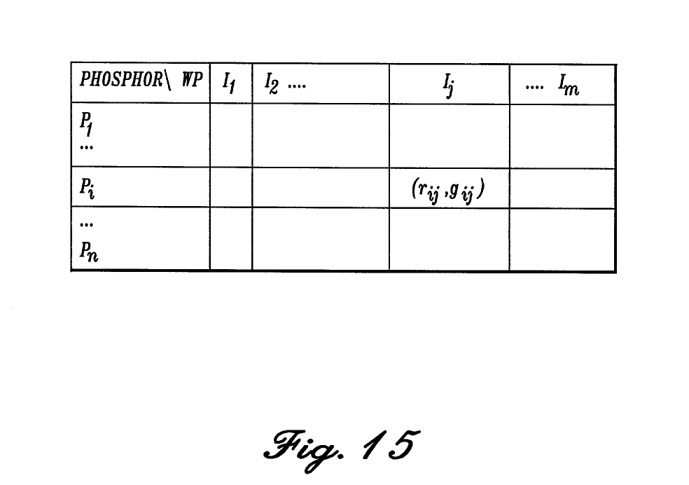

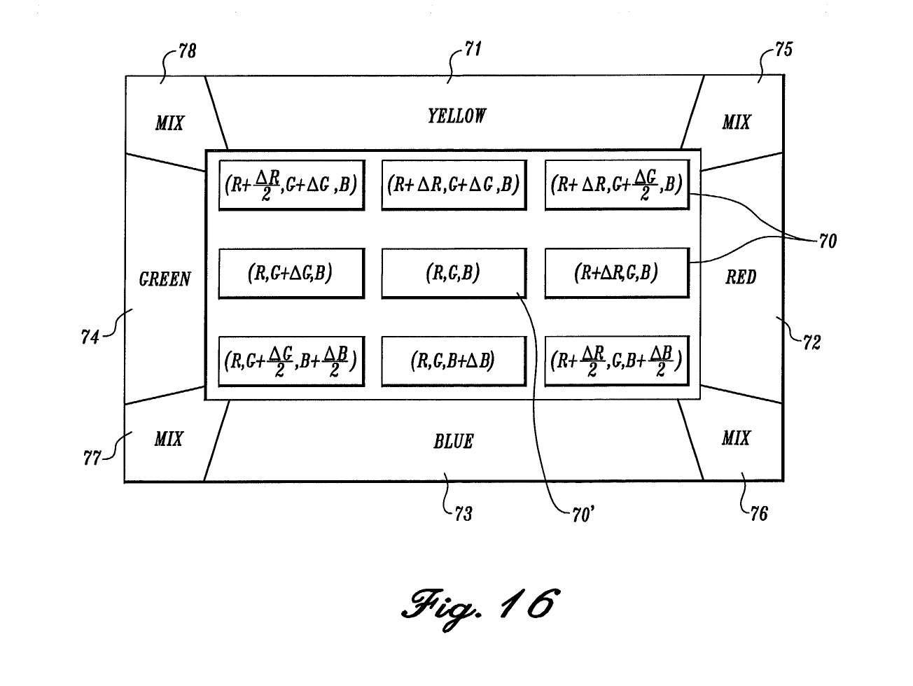

Thus obtained reference neutral value index (rᵢⱼ, gᵢⱼ) is stored in a table, corresponding to the particular phosphor type Pᵢ and white point class Iⱼ, as shown in FIG. 15.

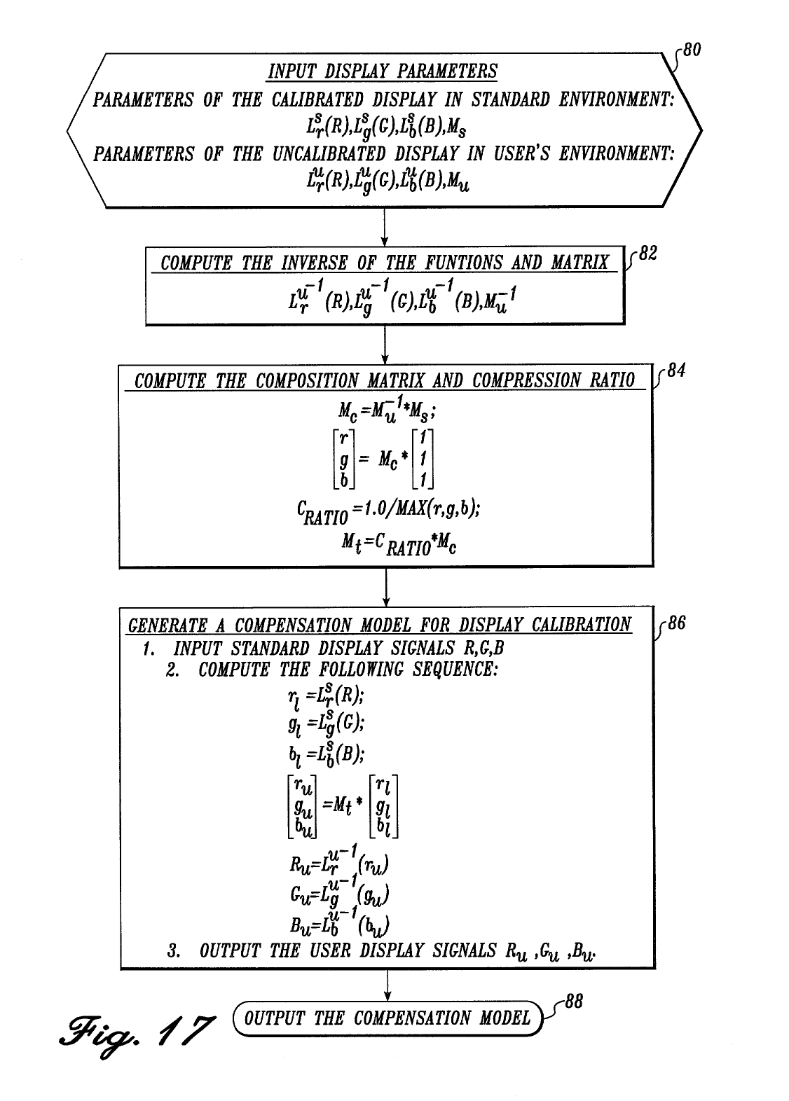

Next, an image pattern as shown in FIG. 16 is constructed on the display 12 for the user to view, so that the user can determine which of nine tiles 70 appears most color neutral. (This determination will be later used to determine, in turn, which matrix Mᵢⱼ having a particular neutral value index (rᵢⱼ, gᵢⱼ) best fits the user display.) First, in step 54, initial (R, G, B) signal values for filling in the central tile 70′ are determined so as to satisfy:

R=HPRᵣ^{u-1}(½);

G=HPR_{g}^{u-1}(½);

B=HPR_{b}^{u-1}(½) (25)

SUM=R+G+B (26)

The equations (25) indicate the signal code values in red, green, and blue channels, respectively, that produce one half of human perception response (normalized) on the user display (see FIG. 7). Also, the “refine scale” of just noticeable difference (JND unit) is set (as 2.0 in the illustrated embodiment). The refine scale is a variable for downsizing the search range of ΔR, ΔG, and ΔB, in each iterated process of viewing the image pattern of FIG. 16, as more fully described below. Thus,

HPR′(x)=refine scale/Δx (27)

In step 56, as illustrated in FIG. 16, an exemplary picture, including nine tiles 70, is created, each tile being color coded with a varying code signal, wherein:

ΔR=refine scale/HPRᵣ^{u′}(R);;

ΔG=refine scale/HPR_{g}^{u′}(G);

ΔB=refine scale/HPR_{b}^{u′}(B). (28)

In a next step 58, the image of FIG. 16 is shown on the display 12 to the user. At this time, four edges of the display 71, 72, 73, and 74 are respectively colored in yellow, red, blue, and green. Further, these four colors merge at four corners 75, 76, 77, and 78 as these edges merge together. For example, the corner 75 is colored in a mixture of yellow and red, and the corner 76 is colored in a mixture of red and blue.

The user is then prompted to select which of the nine tiles 70 appears most color-wise neutral among yellow, red, blue, and green colors. The user, by using the colored edges 71, 72, 73, and 74 as reference colors, selects one tile that appears neutral to him, i.e., the tile that cannot be characterized as either yellow, red, blue, or green (typically a somewhat grayish color). If the user makes this selection (step 60), and the selected tile is not the central tile 70′ (step 62), the signals coding the selected tile are set as (R*, G*, B*), and SUM*=R*+G*+B*. Then, R, G, B for color coding the seven tiles 70 are reset as follows (step 66):

R=R*×SUM/SUM*;

G=G*×SUM/SUM*;

B=B*×SUM/SUM*. (29)

Then, returning to step 56, the signals for coloring the tiles 70 in FIG. 16 are reset according the newly determined R, G, B values in equation (29), and the user is again prompted to select the most neutral tile (step 58). If, in step 62, it is determined that the tile selected by the user as most neutral is the central tile 70′, to obtain more detailed information based on smaller increments of just noticeable difference, in step 64, the refine scale (currently set as 2.0) is made smaller, for example to (2.0×0.7), in the illustrated embodiment. Then, the process returns to step 56, wherein the tiles 70 in FIG. 16 are reset according to the original R, G, B, values but with newly calculated ΔR, ΔG, ΔB values based on the new refine scale (see equation (28)), and in step 58 the user is prompted to select the most neutral tile.

The process is repeated until, in step 60, it is determined that the user can no longer differentiate which tile is the most neutral, i.e., until all nine tiles 70 appear equally neutral to the user. Then, in step 65, R, G, B values at that point are identified as R*, G*, B*, which are the neutral color signals for the user display.

In a next step 67, the difference distance dᵢⱼ between the user display and each of the plurality of predefined display models each characterized by calorimetric matrix Mᵢⱼ is determined, based on the following set of equations:

b=L_{b}^{u}(B*);

Rᵢⱼ=Lᵣ^{u}^{⁻¹}(rᵢⱼ×b);

Gᵢⱼ=L_{g}^{u}^{⁻¹}(gᵢⱼ×b);

σᵣ^{*}=1/HPR^{u′}ᵣ(R*)

σᵣ^{*}=1/HPR^{u′}_{g}(G*)

$$d = \frac{\vert {R}^{*} - {R}_{ij} \vert}{{σ}_{r}^{*}} + \frac{\vert {G}^{*} - {G}_{ij} \vert}{{σ}_{g}^{*}} . \qquad ( 30 )$$

Once dᵢⱼ is obtained for each of Mᵢⱼ matrices, in step 68, the minimum distance dᵤᵥ is selected from the plurality of dᵢⱼ. Then, colorimetric matrix Mᵤᵥ of phosphor type u and white point class v corresponding to dᵤᵥ is selected as an estimate of the colorimetric transformation matrix for the user display, Mᵤ. Finally, in step 69, thus obtained Mᵤ of the user display is output.

### D. Generating a Look-Up Table (LUT)

Finally, referring back to FIG. 2, at block D, a color compensation table, or a look-up table (LUT), is constructed, which can be referenced to convert RGB signals transmitted over the Internet and received by the user's display into RᵤGᵤBᵤ signals, calibrated for the user display, for producing the same color images on the user's display as the original images. Referring to FIG. 17, in step 80, the luminance response functions for the standard display L^{s}(x) for red, green, and blue channels (from equations (4), (5), and (6) above) and the calorimetric transformation matrix Mₛ for the standard display (from matrix equation (3) above) are retrieved as input. Further, the luminance functions estimated for the user display L^{u}(x) for red, green, and blue channels (from equation (19) above) and the user display's calorimetric transformation matrix Mᵤ, which has just been obtained above, are retrieved as input.

In a next step 82, the inverse of the luminance functions and matrix for the user display are obtained, specifically, Lᵣ^{u}^{⁻¹}(R), L_{g}^{u}^{⁻¹}(G), L_{b}^{u}^{⁻¹}(B), and Mᵤ⁻¹.

In a next step 84, a composition matrix M_{c} and a compression ratio Cᵣₐₜᵢₒ are calculated as follows:

M_{c}=Mᵤ⁻¹*Mₛ

$$\begin{matrix}{M}_{c} = {M}_{u}^{- 1} * {M}_{s} \\ [ \begin{matrix}r \\ g \\ b\end{matrix} ] = {M}_{c} * [ \begin{matrix}1 \\ 1 \\ 1\end{matrix} ] \\ {C}_{ratio} = 1.0 / max ( r , g , b ) ; \\ {M}_{t} = {C}_{ratio} * {M}_{c}\end{matrix} \qquad ( 31 )$$

Cᵣₐₜᵢₒ=1.0/max(r,g,b);

Mₜ=Cᵣₐₜᵢₒ*M_{c}

The function “max (r,g,b)” takes the maximum value among r, g, and b. Cᵣₐₜᵢₒ is a clamping signal factor that is used to avoid converted signal overload. For example, the composition matrix M_{c} may convert standard display signals (R,G,B)=(255, 255, 255) to the user display signals (Rᵤ,Gᵤ,Bᵤ)=(258, 250, 239), wherein Rᵤ=258 exceeds the maximum signal value 255 in an 8-bit system. To prevent such signal overloading, signal conversion should be scaled down by a factor of 255/258, which is the compression ratio in this example. Thus, by scaling the composition matrix M_{c} by the compression ratio Cᵣₐₜᵢₒ, one can obtain a clamping transformation matrix Mₜ. When Mₜ is used to convert standard display signals RGB to the user's display signals RᵤGᵤBᵤ, no converted signal shall exceed the maximum signal value in a particular system (e.g., an 8-bit system).

Next in step 86, a compensation model, or the LUT 20 (FIG. 1B) for converting RGB signals to RᵤGᵤBᵤ signals is constructed as follows:

When RGB signals are received, calculate as follows:

rₗLᵣ^{s}(R);

gₗL_{g}^{s}(G);

bₗL_{b}^{s}(B);

$$\begin{matrix}{r}_{l} = {L}_{r}^{s} ( R ) ; \\ {g}_{l} = {L}_{g}^{s} ( G ) ; \\ {b}_{l} = {L}_{b}^{s} ( B ) ; \\ [ \begin{matrix}{r}_{u} \\ {g}_{u} \\ {b}_{u}\end{matrix} ] = {M}_{t} * [ \begin{matrix}{r}_{l} \\ {g}_{l} \\ {b}_{l}\end{matrix} ] \\ {R}_{u} = {L}_{r}^{{u}^{- 1}} ( {r}_{u} ) \\ {G}_{u} = {L}_{g}^{{u}^{- 1}} ( {g}_{u} ) \\ {B}_{u} = {L}_{b}^{{u}^{- 1}} ( {b}_{u} )\end{matrix} \qquad ( 32 )$$

Rᵤ=Lᵣ^{u}^{⁻¹}(rᵤ)

Gᵤ=L_{g}^{u}^{⁻¹}(gᵤ)

Bᵤ=L_{b}^{u}^{⁻¹}(bᵤ)

In step 88, the LUT 20 (the compensation model) as defined in the equation set (32) is output. In operation, when a user's display receives RGB signals, perhaps via the Internet, the LUT 20 is used to convert the RGB signals to RᵤGᵤBᵤ signals for the particular user display. The RᵤGᵤBᵤ signals are then used to reproduce images on the user's display in the same color appearance as the original images.

Accordingly, the present invention provides a system and method for calibrating a user display, so that the user display can successfully convert standard RGB signals to RᵤGᵤBᵤ signals to reproduce images on the user display in the same color appearance as the original images. The system offers a simple and straightforward user interface to permit easy implementation of the method of the invention. Specifically, the only steps that a user of an uncalibrated display needs to perform according to the present invention are to: (1) in response to the system prompt, indicate his surrounding environment (dim, average, or bright) (see FIG. 10); (2) in response to the system prompt, repeatedly select images with just noticeable differences therebetween (see FIG. 5, for creating three HPR curves for red, green, and blue channels); and (3) in response to the system prompt, repeatedly select a tile that appears most neutral until all tiles appear equally neutral (see FIG. 16, for estimating a calorimetric transformation matrix for the user display). Clearly, these steps can be performed without any knowledge of colorimetry, and thus can be readily performed by a layman, a typical Internet user. The computations involved in the method are all autonomously performed by the system, and thus transparent to the user.

While the preferred embodiments of the invention have been illustrated and described, it will be appreciated that various changes can be made therein without departing from the spirit and scope of the invention. For example, while the present invention has been described above as applied in an RGB tristimulus system, it should be understood by those skilled in the art that the present invention is equally applicable in other tristimulus systems or in a monochromatic system. Further, while in the present description, an observer's surrounding environment is categorized into three environments (dim, average, and bright) for the purpose of obtaining human perception response (HPR) curves, the surrounding environment may be categorized into more or less than three environments, also. In any event, a user display HPR curve obtained in a certain surrounding environment is compared with a standard display HPR curve obtained in the same or similar surrounding environment.

The embodiments of the invention in which an exclusive property or privilege is claimed are defined as follows:

1. A method for visually calibrating a user display using just-noticeable-difference of human perception response, comprising the steps of:
(a) creating a standard display model, the model comprising:
(i) a standard display calorimetric transformation matrix,
(ii) a standard display luminance response function, and
(iii) three standard display human perception response (HPR) curves in dim, average, and bright surrounding environments, respectively;
(b) creating a user display model, the model comprising:
(i) a user display colorimetric transformation matrix, which is not fully defined,
(ii) a user display luminance response function, which is not fully defined, and
(iii) a user display human perception response (HPR) curve in dim, average, or bright surrounding environment as specified by the user;
(c) estimating the user display luminance response function based on the standard display luminance response function of step (a)(ii), the standard display HPR curve of step (a)(iii) associated with the surrounding environment as specified by the user, and the user display HPR curve of step (b)(iii);
(d) estimating the user display colorimetric transformation matrix; and
(e) creating a lookup-table (LUT) for converting standard display signals to user display signals, based on the user display luminance response function estimated in step (c) and the user display calorimetric transformation matrix estimated in step (d).

2. The method of claim 1, wherein each of the standard display HPR curve and the user display HPR curve is obtained by a submethod comprising the steps of:
(A) displaying a pattern on a screen wherein a plurality of images coded with a plurality of color signal values, respectively, are displayed;
(B) prompting an observer to select two images that have a just-noticeable-difference therebetween;
(C) recording two color signal values corresponding to the two images having, according to the observer, a just-noticeable-difference; and
(D) repeating steps (A) thorough (C) until just-noticeable-differences are defined for signal values ranging from 0 to a maximum signal value.

3. The method of claim 2, wherein the pattern displayed in step (A) comprises a first series of images arranged in a first row and a second series of images arranged in a second row, the first and second rows are parallel with each other, the first and second series of images are identical to each other, the images in the first row are all coded with a color signal value that is selected to render the images in the first row clearly visible to the observer, and the images in the second row are coded with differing color signal values having differing degrees of visibility to the observer.

4. The method of claim 1, wherein the standard display HPR curve and the user display HPR curve are normalized.

5. The method of claim 1, wherein step (d) further comprises:
(i) predefining a plurality of calorimetric transformation matrices corresponding to a plurality of display models, respectively;
(ii) determining neutral color signals that produce a neutral color on the user display as seen by the user;
(iii) calculating a difference distance between the user display and each of the plurality of display models, based on the neutral color signals of the user display determined in step (ii) above; and
(iv) selecting the calorimetric transformation matrix of a display model that has the minimum difference distance from the user display.

6. The method of claim 5, wherein step (d)(ii) of determining neutral color signals of the user display further comprises the steps of:
(A) displaying a pattern on the user display wherein a plurality of images coded with a plurality of color signal values, respectively, are displayed;
(B) prompting the user to select one image that appears most color neutral; and
(C) repeating steps (A) and (B), each time varying the plurality of color signal values for coding the plurality of images, respectively, until the user cannot select one image as most color neutral.

7. The method of claim 6, wherein the pattern displayed in step (d)(ii)(A) comprises a matrix of images, the matrix of images being surrounded by four edges forming a generally rectangular frame, and the four edges being colored in green, yellow, red, and blue, respectively, so as to assist the user in selecting the most color neutral image in reference to the colored edges.

8. The method of claim 1, wherein step (e) further comprises:
(i) obtaining a composition matrix based on the standard display colorimetric transformation matrix obtained in step (a)(i) and the user display calorimetric transformation matrix estimated in step (d); and
(ii) compressing the composition matrix to obtain a clamping transformation matrix.

9. The method of claim 8, wherein a submethod of converting standard display signals to the user display signals using the lookup-table (LUT) of step (e) comprises the steps of:
(A) receiving a standard display signal;
(B) calculating a luminance response of the standard display signal using the standard display luminance response function of step (a)(ii);
(C) using the clamping transformation matrix, transforming the luminance response obtained in step (B) above to a desired luminance response for the user display;
(D) obtaining an inverse of the user display luminance response function estimated in step (c); and
(E) plugging the desired luminance response for the user display obtained in step (C) above into the inverse of the user display luminance response function obtained in step (D) above, obtaining a user display signal corresponding to the received standard display signal.

10. The method of claim 1, wherein the user display comprises a tristimulus system, and the standard display luminance response function in step (a)(ii), the three standard display human perception response (HPR) curves in step (a)(iii), the user display luminance response function in step (b)(ii), and the user display human perception response (HPR) curve in step (b)(iii) are all obtained and processed for three tristimulus values, respectively.

11. The method of claim 10, wherein the tristimulus system is an RGB system.

12. A computer-readable medium having computer-executable instructions for allowing a user to visually calibrate a user display using just-noticeable-difference of human perception response, the instructions comprising a prestored standard display model that comprises: (1) a standard display calorimetric transformation matrix, (2) a standard display luminance response function, and (3) three standard display human perception response (HPR) curves in dim, average, and bright surrounding environments, respectively; and the instructions, when loaded into a computer, causing the computer to execute the steps of:
(a) prompting a user to specify the user's surrounding environment as dim, average, or bright;
(b) creating a user display model, the model comprising:
(i) a user display calorimetric transformation matrix, which is not fully defined,
(ii) a user display luminance response function, which is not fully defined, and
(iii) a user display human perception response (HPR) curve in dim, average, or bright surrounding environment as specified by the user in step (a) above;
(c) estimating the user display luminance response function based on the prestored standard display luminance response function, the prestored standard display HPR curve associated with the surrounding environment as specified by the user in step (a), and the user display HPR curve of step (b)(iii) above;
(d) estimating the user display colorimetric transformation matrix; and
(e) creating a lookup-table (LUT) for converting standard display signals to user display signals, based on the user display luminance response function estimated in step (c) and the user display calorimetric transformation matrix estimated in step (d).

13. The medium of claim 12, wherein the user display HPR curve is obtained by a submethod comprising the steps of:
(A) displaying a pattern on the user display wherein a plurality of images coded with a plurality of color signal values, respectively, are displayed;
(B) prompting the user to select two images that have a just-noticeable-difference therebetween;
(C) recording two color signal values corresponding to the two images having, according to the user, a just-noticeable-difference; and
(D) repeating steps (A) thorough (C) until just-noticeable-differences are defined for signal values ranging from 0 to a maximum signal value.

14. The medium of claim 13, wherein the pattern displayed in step (A) comprises a first series of images arranged in a first row and a second series of images arranged in a second row, the first and second rows are parallel with each other, the first and second series of images are identical to each other, the images in the first row are all coded with a color signal value that is selected to render the first series of images clearly visible to the user, and the images in the second row are coded with differing color signal values having differing degrees of visibility to the user.

15. The medium of claim 12, wherein step (d) further comprises:
(i) retrieving a plurality of predefined calorimetric transformation matrices corresponding to a plurality of display models, respectively;
(ii) determining neutral color signals that produce a neutral color on the user display as seen by the user;
(iii) calculating a difference distance between the user display and each of the plurality of display models, based on the neutral color signals of the user display determined in step (ii) above; and
(iv) selecting the calorimetric transformation matrix of a display model that has the minimum difference distance from the user display.

16. The medium of claim 15, wherein step (d)(ii) of determining neutral color signals of the user display further comprises the steps of:
(A) displaying a pattern on the user display wherein a plurality of images coded with a plurality of color signal values, respectively, are displayed;
(B) prompting the user to select one image that appears most color neutral; and
(C) repeating steps (A) and (B), each time varying the plurality of color signal values for coding the plurality of images, respectively, until the user can no longer select one image as most color neutral.

17. The medium of claim 16, wherein the pattern displayed in step (d)(ii)(A) comprises a matrix of images, the matrix of images being surrounded by four edges forming a generally rectangular frame, and the four edges being colored in green, yellow, red, and blue, respectively, so as to assist the user in selecting the most color neutral image in reference to the colored edges.

18. The medium of claim 12, wherein step (e) further comprises:
(i) obtaining a composition matrix based on the prestored standard display colorimetric transformation matrix and the user display colorimetric transformation matrix estimated in step (d); and
(ii) compressing the composition matrix to obtain a clamping transformation matrix.

19. The medium of claim 18, wherein a submethod of converting standard display signals to the user display signals using the lookup-table (LUT) of step (e) comprises the steps of:
(A) receiving a standard display signal;
(B) calculating a luminance response of the standard display signal using the prestored standard display luminance response function;
(C) using the clamping transformation matrix, transforming the luminance response obtained in step (B) above to a desired luminance response for the user display;
(D) obtaining an inverse of the user display luminance response function estimated in step (c); and
(E) plugging the desired luminance response for the user display obtained in step (C) above into the inverse of the user display luminance response function obtained in step (D) above, obtaining a user display signal corresponding to the received standard display signal.

20. The medium of claim 12, wherein the user display comprises a tristimulus system, three standard display luminance response functions are prestored for three tristimulus values, respectively; nine standard display human perception response (HPR) curves are prestored for three tristimulus values, each in dim, average, and bright environments, respectively; three user display luminance response functions for three tristimulus values, respectively, are obtained in (b)(ii) and estimated in (c); and three user display human perception response (HPR) curves for three tristimulus values, respectively, are obtained in (b)(iii).

21. The medium of claim 20, wherein the tristimulus system is an RGB system.

22. A method for visually calibrating a user display using just-noticeable-difference of human perception response, comprising the steps of:
(a) creating a standard display model, the model comprising:
(i) a standard display colorimetric transformation matrix,
(ii) a standard display luminance response function, and
(iii) at least one standard display human perception response (HPR) curve;
(b) creating a user display model, the model comprising:
(i) a user display calorimetric transformation matrix, which is not fully defined,
(ii) a user display luminance response function, which is not fully defined, and
(iii) a user display human perception response (HPR) curve;
(c) estimating the user display luminance response function based on the standard display luminance response function of step (a)(ii), the standard display HPR curve of step (a)(iii), and the user display HPR curve of step (b)(iii);
(d) estimating the user display colorimetric transformation matrix; and
(e) creating a lookup-table (LUT) for converting standard display signals to user display signals, based on the user display luminance response function estimated in step (c) and the user display colorimetric transformation matrix estimated in step (d).

23. The method of claim 22, wherein a plurality of standard display HPR curves are defined in step (a)(iii) in a plurality of surrounding environments, respectively, and in step (c) the user display luminance function is estimated based on one of the plurality of standard display HPR curves, which is defined in an environment closest to an environment in which the user display HPR curve is obtained.

24. A computer user-interface system for allowing a user to visually calibrate a user display using just-noticeable-difference of human perception response, the system comprising a prestored standard display model that comprises: (A) a standard display colorimetric transformation matrix, (B) a standard display luminance response function, and (C) at least one standard display human perception response (HPR) curve; and the system further comprising:
means for defining a human perception response (HPR) curve for the user display;
means for estimating a luminance response function of the user display;
means for estimating a calorimetric transformation matrix of the user display; and
means for creating a look-up table (LUT) for converting standard display signals to user display signals.

25. The system of claim 24, wherein a plurality of standard display HPR curves are predefined in a plurality of surrounding environments, respectively, and prestored, and the system further comprises means for prompting the user to specify the user's surrounding environment.

26. The system of claim 25, wherein three standard display HPR curves are predefined in dim, average, and bright environment, respectively, and the means for prompting the user to specify the user's surrounding environment provides three choices: dim, average, and bright surrounding environments.

27. The system of claim 24, wherein the means for defining an HPR curve for the user display further comprises:
means for displaying a pattern on the user display wherein a plurality of images coded with a plurality of color signal values, respectively, are displayed;
means for prompting the user to select two images that have a just-noticeable-difference therebetween; and
means for recording two color signal values corresponding to the two images having, according to the user, a just-noticeable-difference.

28. The system of claim 27, wherein the pattern displayed on the user screen comprises a first series of images arranged in a first row and a second series of images arranged in a second row, the first and second rows are parallel with each other, the first and second series of images are identical to each other, the images in the first row are all coded with a color signal value that is selected to render the images in the first row clearly visible to the user, and the images in the second row are coded with differing color signal values having differing degrees of visibility to the user.

29. The system of claim 24, wherein a plurality of calorimetric transformation matrices corresponding to a plurality of display models, respectively, are predefined and prestored, and the means for estimating a calorimetric transformation matrix of the user display further comprises:
means for determining neutral color signals that produce a neutral color on the user display as seen by the user;
means for calculating a difference distance between the user display and each of the plurality of predefined display models, based on the neutral color signals of the user display; and
means for selecting the calorimetric transformation matrix of a display model that has the minimum difference distance from the user display.

30. The system of claim 29, wherein the means for determining neutral color signals on the user display further comprises:
means for displaying a pattern on the user display wherein a plurality of images coded with a plurality of color signal values, respectively, are displayed; and
means for prompting the user to select one image that appears most color neutral.

31. The system of claim 30, wherein the pattern displayed on the user display comprises a matrix of images, the matrix of image being surrounded by four edges forming a generally rectangular frame, and the four edges being colored in green, yellow, red, and blue, respectively, so as to assist the user in selecting the most color neutral image in reference to the colored edges.

32. The system of claim 24, wherein the means for creating a LUT further comprises means for obtaining a composition matrix based on the standard display colorimetric transformation matrix and the user display calorimetric transformation matrix.

33. The system of claim 32, further comprising a subsystem for converting standard display signals to the user display signals using the lookup-table (LUT), the subsystem comprising:
means for receiving a standard display signal;
means for calculating a luminance response of the standard display signal using the standard display luminance response function;
means for transforming the luminance response of the standard display signal to a desired luminance response for the user display, using the composition matrix; and
means for obtaining a user display signal corresponding to the received standard display signal, based on the desired luminance response of the user display signal, using an inverse of the user display luminance response function.
